(19) United States
(12) Patent Application Publication
(10) Pub. No.: US 2026/0229777 A1
(43) Pub. Date: Aug. 6, 2026

(54) ANTENNA MODULE AND ELECTRONIC DEVICE

(71) Applicant: COMPAL ELECTRONICS, INC., Taipei City (TW)

(72) Inventors: Yu-Hui Yeh, Taipei City (TW); Shih-Chia Liu, Taipei City (TW); Yen-Hao Yu, Taipei City (TW); Jhih-Ciang Chen, Taipei City (TW); Chih-Heng Lin, Taipei City (TW); Shih-Ping Liu, Taipei City (TW)

(73) Assignee: COMPAL ELECTRONICS, INC., Taipei City (TW)

(21) Appl. No.: 19/232,872

(22) Filed: Jun. 10, 2025

(30) Foreign Application Priority Data
Feb. 5, 2025 (TW) 114104127

(51) Int. Cl. H01Q 5/30; H01Q 1/22; H01Q 5/50; H04R 3/00

(52) U.S. Cl. CPC H01Q 5/30; H01Q 1/22; H01Q 5/50; H04R 3/00; H04R 2420/07

(57) ABSTRACT

An antenna module includes a carrier, a grounding part, a first and a second radiation part, a feeding part, and a matching part. The first radiation part and the grounding part are respectively located on the carrier’s top and bottom sides. The feeding part is located between the grounding part and the first radiation parts. The first radiation part is excited by the feeding part and connected with the grounding part to resonate a first resonant frequency band. The second radiation part is located between the first radiation part and the grounding part. A first coupling gap is between the first and the second radiation part. The matching part is located between the first radiation part and the grounding part and is adjacent to the second radiation part which is coupled with the first radiation part through the first coupling gap to resonate a second resonant frequency band.

### CROSS-REFERENCE TO RELATED APPLICATION

This application claims the priority benefit of Taiwan application serial no. 114104127, filed on February 5, 2025. The entirety of the above-mentioned patent application is hereby incorporated by reference herein and made a part of this specification.

### BACKGROUND

### Technical Field

This disclosure relates to an antenna module and an electronic device.

### Description of Related Art

Existing portable electronic devices such as laptop computers and smartphones mostly have wireless communication functions. Generally, laptop computers are equipped with antennas to receive or transmit radio waves. Currently, with an emphasis on appearance, most laptop computers adopt an all-metal design for the body. In this environment, a clearance area is usually created in either the keyboard bezel (also known as component C) or the bottom casing (also known as component D) to overcome the effects of metal. However, for antennas, there are certain requirements for the size of the clearance area and the spacing between the metal casing. In the event that one of the metal casings, either component C or component D, lacks an antenna clearance area, the design of the spacing between the antenna and the other metal casing becomes critically important. Especially in the design of thin and lightweight products, if the antenna is too close to the metal casing, it may affect the antenna impedance, resulting in insufficient operating bandwidth.

Therefore, how to maintain the appearance design of the electronic device while taking into account the radiation characteristics of the antenna has become one of the problems to be solved in this field.

### SUMMARY

The disclosure provides an antenna module that has a wider operating bandwidth performance.

The disclosure provides an electronic device that includes the antenna module.

The antenna module of the disclosure includes a carrier, a grounding part, a first radiation part, a feeding part, a second radiation part, and a matching part. The grounding part is located on a bottom side of the carrier. The first radiation part is located on a top side of the carrier. The feeding part is located between the grounding part and the first radiation part, the first radiation part is excited by the feeding part and connected to the grounding part, resonating to generate a first resonant frequency band. The second radiation part is located between the first radiation part and the grounding part, the second radiation part is connected to the grounding part, and a first coupling gap is between the second radiation part and the first radiation part. The matching part is located between the first radiation part and the grounding part, and adjacent to the second radiation part. The second radiation part couples with the first radiation part through the first coupling gap, resonating to generate a second resonant frequency band.

The electronic device of the disclosure includes a first metal casing, a second metal casing, and the antenna module. The second metal casing is assembled on the first metal casing, and the second metal casing has a window. The antenna module is disposed between the first metal casing and the second metal casing and adjacent to the window, with the bottom side of the carrier facing the first metal casing and the top side of the carrier facing away from the first metal casing.

In an embodiment of the disclosure, the matching part may be T-shaped, square, or L-shaped.

In an embodiment of the disclosure, a length of the second radiation part may be 1/4 wavelength of the second resonant frequency band.

In an embodiment of the disclosure, the second radiation part and the matching part may form an open slot.

In an embodiment of the disclosure, an open end of the open slot faces towards the first radiation part.

In an embodiment of the disclosure, the first radiation part is separated from the matching part.

In an embodiment of the disclosure, the antenna module further includes a flexible circuit board covering the carrier. The grounding part, the first radiation part, the second radiation part, and the matching part are disposed on the flexible circuit board.

In an embodiment of the disclosure, the grounding part, the first radiation part, the second radiation part, and the matching part are directly formed on the carrier by laser forming.

In an embodiment of the disclosure, the carrier is a speaker.

In an embodiment of the disclosure, the carrier further includes a first side and a second side opposite to each other, located between the top side and the bottom side and perpendicular to the top side and the bottom side. The second radiation part and the matching part located on the first side. The grounding part extends to the second side.

In an embodiment of the disclosure, the carrier further includes a third side and a fourth side opposite to each other, located between the top side and the bottom side. The third side and the fourth side are perpendicular to the top side and the bottom side, and perpendicular to the first side and the second side. The grounding part extends to the third side and the fourth side.

In an embodiment of the disclosure, the second radiation part and matching part are located on the top side, the carrier further includes a first side and a second side opposite to each other, located between the top side and the bottom side and perpendicular to the top side and the bottom side, and the grounding part extends to the first side and the second side.

In an embodiment of the disclosure, the top side is a plane.

In an embodiment of the disclosure, at least a portion of the top side is inclined relative to the bottom side.

Based on the above, in the antenna module of the disclosure, the first radiation part is located on the top side of the carrier, the grounding part is located on the bottom side of the carrier, and the second radiation part and the matching part are located between the first radiation part and the grounding part. The feeding part is located between the grounding part and the first radiation part. The first radiation part is excited by the feeding part and connected to the grounding part, to generate a first resonant frequency band. The second radiation part couples with the first radiation part through a first coupling gap between the second radiation part and the first radiation part, resonating to generate a second resonant frequency band. As a result, the antenna module may be applied in thin and lightweight product designs, employing the dual resonant mode design to improve the problem of insufficient operating bandwidth, thereby enabling the antenna module to exhibit a wider operating bandwidth performance, while also maintaining good antenna efficiency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a three-dimensional schematic diagram of an antenna module according to an embodiment of the disclosure.

FIG. 1B is a three-dimensional schematic diagram of the antenna module of FIG. 1A from another viewing angle.

FIG. 2 is a relationship diagram of frequency versus S-parameter of an antenna module according to an embodiment of the disclosure.

FIG. 3 is a three-dimensional schematic diagram of an antenna module according to an embodiment of the disclosure.

FIG. 4A is a side view schematic diagram of the antenna module of FIG. 3.

FIG. 4B is an expanded schematic diagram of a flexible circuit board of the antenna module of FIG. 3.

FIG. 4C is a side view schematic diagram of an antenna module according to an embodiment of the disclosure.

FIG. 4D is an expanded schematic diagram of a flexible circuit board of the antenna module of FIG. 4C.

FIG. 5A is a three-dimensional schematic diagram of an antenna module according to an embodiment of the disclosure.

FIG. 5B is an expanded schematic diagram of a carrier of the antenna module of FIG. 5A.

FIG. 6 is a relationship diagram of frequency versus S parameter between a traditional antenna module and an antenna module according to an embodiment of the disclosure.

FIG. 7A is a three-dimensional schematic diagram of an electronic device according to an embodiment of the disclosure.

FIG. 7B is a partially enlarged three-dimensional schematic diagram of the electronic device of FIG. 7A.

FIG. 7C is a partially enlarged cross-section schematic diagram of the electronic device of FIG. 7B.

FIG. 8A is a partially enlarged three-dimensional schematic diagram of an electronic device according to an embodiment of the disclosure.

FIG. 8B is a partially enlarged cross-section schematic diagram of the electronic device of FIG. 8A.

### DESCRIPTION OF THE EMBODIMENTS

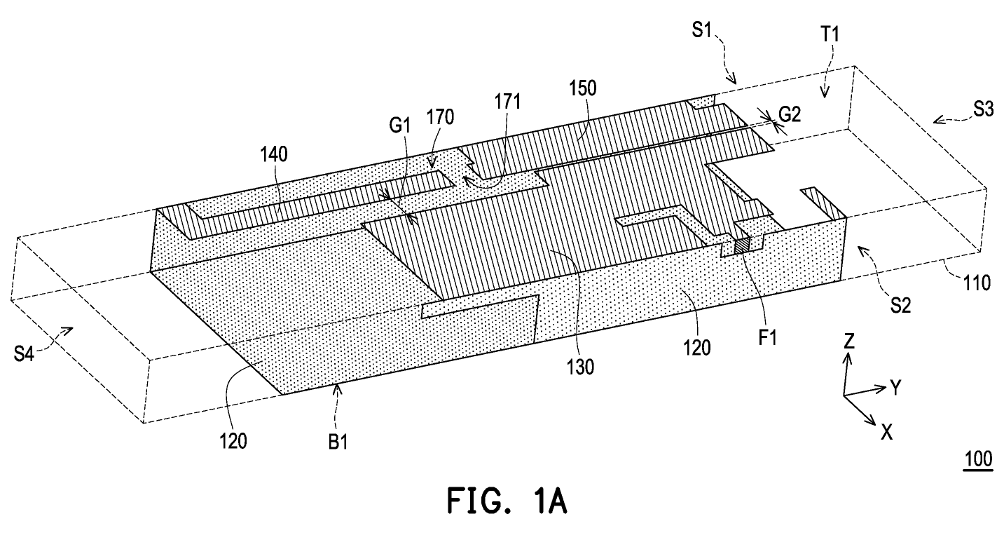

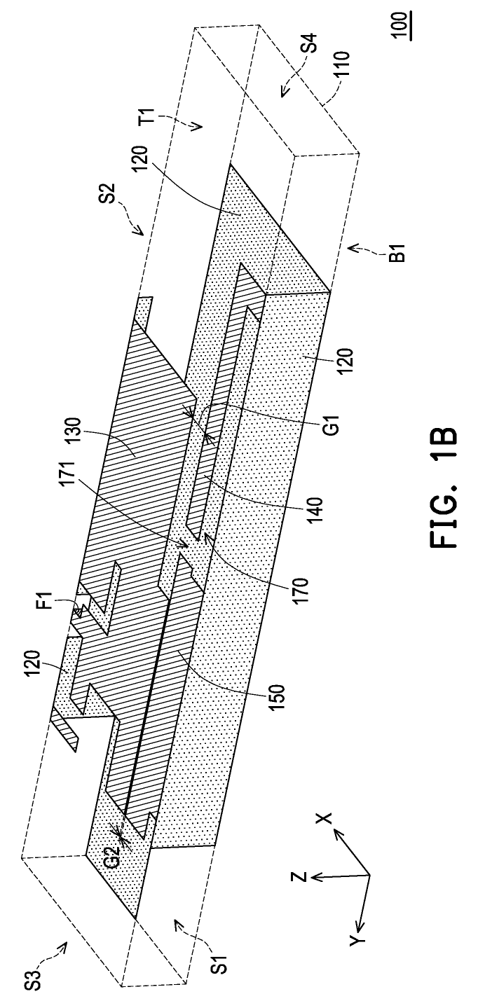

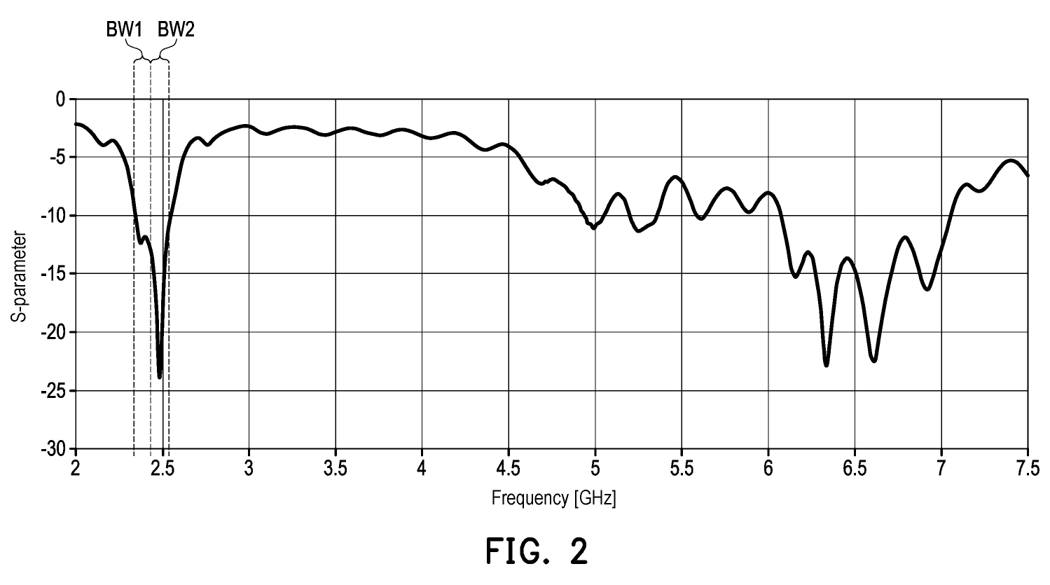

FIG. 1A is a three-dimensional schematic diagram of an antenna module according to an embodiment of the disclosure. FIG. 1B is a three-dimensional schematic diagram of the antenna module of FIG. 1A from another viewing angle. FIG. 2 is a relationship diagram of frequency versus S-parameter of an antenna module according to an embodiment of the disclosure. It should be noted that FIG. 1B is a rear view of an antenna module 100 of FIG. 1A rotated to the back side. To clearly show the relative positions between each component in this embodiment, a carrier 110 in FIG. 1A and FIG. 1B is drawn in a perspective view.

Please refer to FIG. 1A and FIG. 1B, the antenna module 100 of this embodiment includes a carrier 110, a grounding part 120, a first radiation part 130, a feeding part F1, a second radiation part 140, and a matching part 150. In this embodiment, the grounding part 120, the first radiation part 130, the second radiation part 140, and the matching part 150 are formed on the carrier 110 by Laser Direct Structuring (LDS), but in other embodiments, the grounding part, the first radiation part, the second radiation part, and the matching part may also be disposed on a flexible circuit board, and the flexible circuit board may cover the periphery of the carrier to form the antenna module. The disclosure does not impose limitations on this.

In one embodiment, the carrier 110 may be a plastic component, while in other embodiments, the carrier 110 may be a speaker. The disclosure does not impose limitations on this.

In this embodiment, the antenna module 100 is a low profile antenna, but is not limited thereto. In this embodiment, the carrier 110 has a top side T1 and a bottom side B1 opposite to each other, a first side S1 and a second side S2 opposite to each other, and a third side S3 and a fourth side S4 opposite to each other. In this embodiment, the carrier 110 is a hexahedron with a square cross-section, but is not limited thereto. The six faces of the carrier 110 correspond to the top side T1, the bottom side B1, the first side S1, the second side S2, the third side S3, and the fourth side S4, respectively. Specifically, the top side T1 is parallel to the bottom side B1, the first side S1 is parallel to the second side S2, and the third side S3 is parallel to the fourth side S4. The first side S1 and the second side S2 are located between the top side T1 and the bottom side B1 and are perpendicular to the top side T1 and the bottom side B1. The third side S3 and the fourth side S4 are located between the top side T1 and the bottom side B1, and the third side S3 and the fourth side S4 are perpendicular to the top side T1 and the bottom side B1, and perpendicular to the first side S1 and the second side S2.

In this embodiment, the first radiation part 130, the second radiation part 140, and the matching part 150 are located on the top side T1. Here, the top side T1 is illustrated as a plane, but in other embodiments, the top side may also be non-planar. In one embodiment, the top side T1 may be a curved surface or at least a portion of the top side T1 may be inclined relative to the bottom side B1, but the disclosure is not limited to this. In one embodiment, the placement of the second radiation part 140 and the matching part 150 may be adjusted according to the window position of the electronic device to avoid metal walls and improve antenna radiation efficiency, but is not limited thereto.

In this embodiment, the grounding part 120 is located on the second side S2 of the carrier 110, and the grounding part 120 extends to the bottom side B1 and the first side S1 to connect with the second radiation part 140 and the matching part 150. Here, the bottom side B1 serves as a ground plane suitable for grounding by connecting with the metal casing, but the disclosure is not limited thereto.

In this embodiment, the feeding part F1 is located between the grounding part 120 and the first radiation part 130. The first radiation part 130 is excited by the feeding part F1 and connected to the grounding part 120, resonating to generate a first resonant frequency band. In this embodiment, the feeding part F1 is located on the second side S2 of the carrier 110, but in other embodiments, the feeding part may also be on the top side. The disclosure is not limited thereto.

Furthermore, in this embodiment, the second radiation part 140 is located between the first radiation part 130 and the grounding part 120. There is a first coupling gap G1 between the second radiation part 140 and the first radiation part 130, and the second radiation part 140 is connected to the grounding part 120.

In this embodiment, the second radiation part 140 couples with the first radiation part 130 through the first coupling gap G1, resonating to generate a second resonant frequency band.

In this embodiment, the first radiation part 130 does not extend to the third side S3 and the fourth side S4, but is not limited thereto.

In this embodiment, the matching part 150 is located between the first radiation part 130 and the grounding part 120, and adjacent to the second radiation part 140. The first radiation part 130 is separated from the matching part 150, and there is a second coupling gap G2 between the first radiation part 130 and the matching part 150. In this embodiment, the matching part 150 may be used to adjust the second resonant frequency band and the matching of high frequencies.

In this embodiment, the matching part 150 is a branch extending from the grounding part 120, which may be T-shaped, square, or L-shaped, but the disclosure is not limited thereto.

Specifically, in this embodiment, the second radiation part 140 and the matching part 150 form an open slot 170, with an open end 171 of the open slot 170 facing towards the first radiation part 130. In other words, the open slot 170 is located between the second radiation part 140 and the matching part 150, but is not limited thereto.

In this embodiment, the length of the second radiation part 140 is 1/4 wavelength of the second resonant frequency band, but the disclosure is not limited thereto.

As shown in FIG. 2, a region BW1 represents the first resonant frequency band, and a region BW2 represents the second resonant frequency band, but is not limited thereto. Under the aforementioned configuration, the antenna module 100 may be applied in thin and lightweight product designs, employing a dual resonant mode design to improve the problem of insufficient operating bandwidth, thereby enabling the antenna module 100 to exhibit a wider operating bandwidth performance.

The following lists other embodiments for illustration. It should be explained here that the following embodiments adopt the reference numerals and partial content from the aforementioned embodiments, using the reference numerals to represent the same or similar components, and omitting explanations of identical technical content. For explanations of the omitted parts, please refer to the previous embodiments. The redundant descriptions are not repeated in the following.

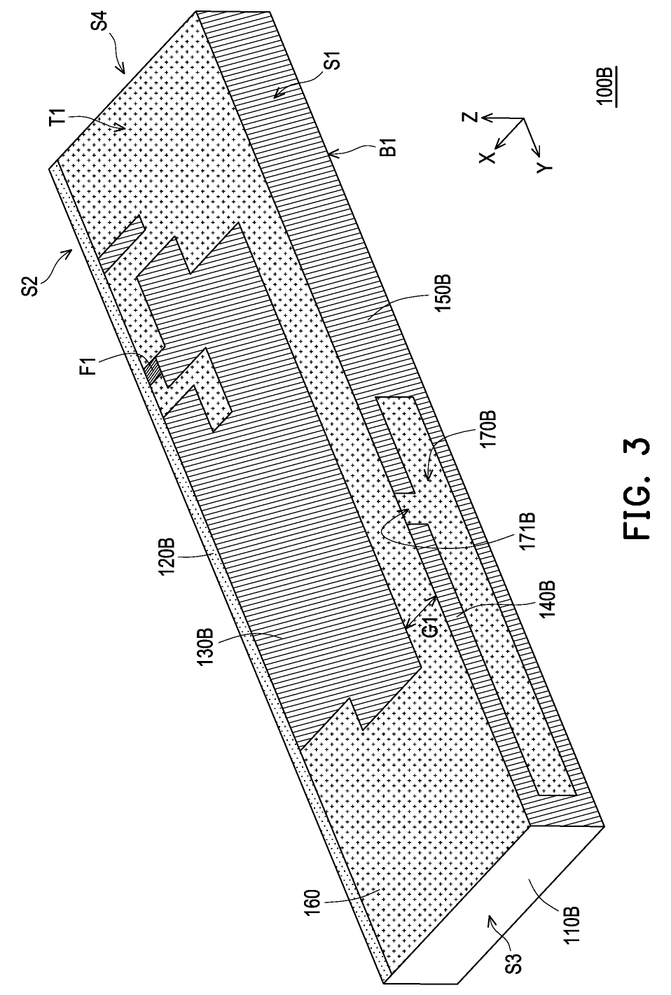

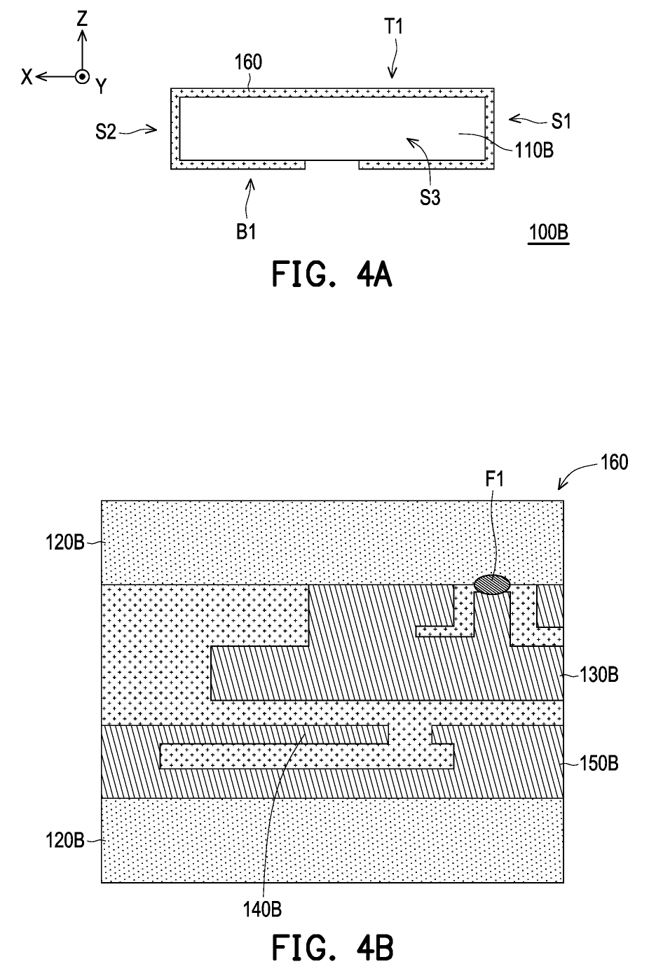

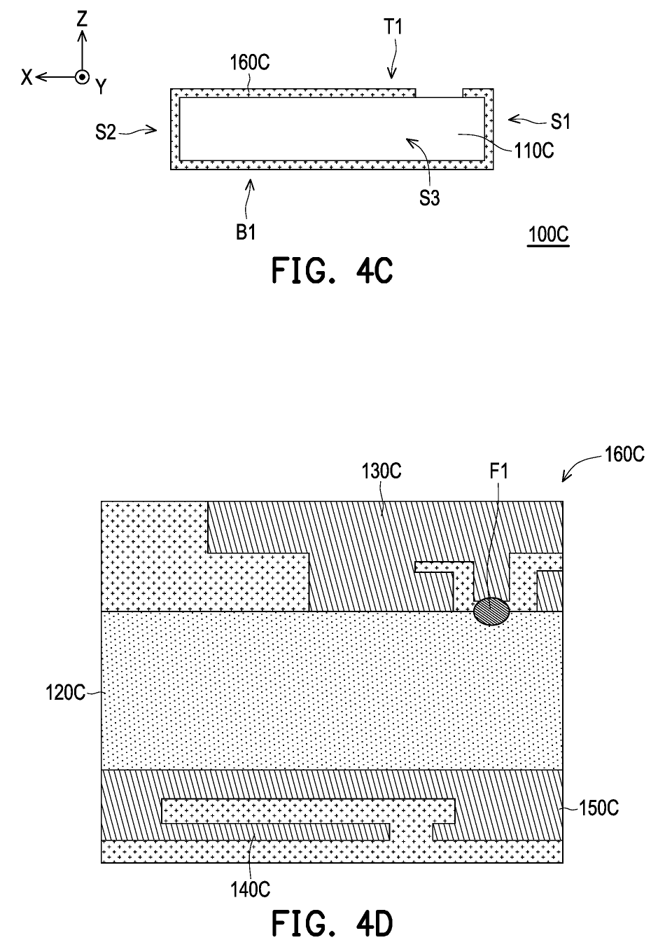

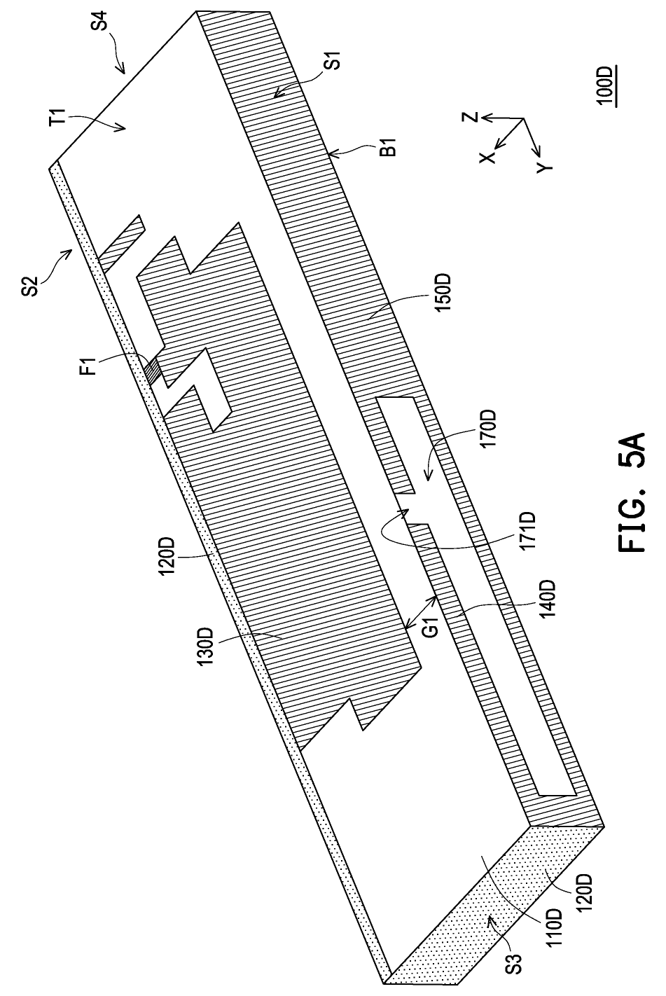

FIG. 3 is a three-dimensional schematic diagram of an antenna module according to an embodiment of the disclosure. FIG. 4A is a side view schematic diagram of the antenna module of FIG. 3. FIG. 4B is an expanded schematic diagram of a flexible circuit board of the antenna module of FIG. 3. To make the diagram clearer, FIG. 4B illustrates a flexible circuit board 160 as unfolded into a plane, while in reality, the flexible circuit board 160 is formed through multiple folds to be able to adhere to the carrier 110. The flexible circuit board 160 illustrated in FIG. 4B only illustrates the relative positions of each component in a simplified manner.

Please refer to FIG. 3 to FIG. 4B. An antenna module 100B of this embodiment includes a carrier 110B, a grounding part 120B, a first radiation part 130B, a feeding part F1, a second radiation part 140B, a matching part 150B, and a flexible circuit board 160. In this embodiment, the second radiation part 140B and the matching part 150B form an open slot 170B, with an open end 171B of the open slot 170B facing towards the first radiation part 130B. Here, the open slot 170B is, for example, T-shaped, but is not limited thereto.

In this embodiment, the grounding part 120B, the first radiation part 130B, the second radiation part 140B, and the matching part 150B are disposed on the flexible circuit board 160, and the flexible circuit board 160 is used to cover the periphery of the carrier 110B to form the antenna module 100B.

In this embodiment, the second radiation part 140B and the matching part 150B are located on a first side S1. In other words, the second radiation part 140B and the matching part 150B are located on the same surface, but are not limited thereto. In this embodiment, at least a portion of the grounding part 120B is located on the bottom side B1, and the grounding part 120B extends from the bottom side B1 to a second side S2, but is not limited thereto.

In this embodiment, the first radiation part 130B is located on a top side T1, while the second radiation part 140B and the matching part 150B are located on the first side S1, respectively positioned on different planes. In this embodiment, the first side S1 is perpendicular to the top side T1, but in other embodiments, the first side may also be inclined to the top side, not limited to this. The placement of the second radiation part 140B and the matching part 150B may be adjusted according to the window position of the electronic device to avoid metal walls and improve antenna radiation efficiency, but is not limited thereto.

Please refer to FIG. 4A. In this embodiment, the two ends of the folded flexible circuit board 160 cover the bottom side B1 of the carrier 110B, with a spacing provided therebetween. This may avoid overlapping of the flexible circuit board 160 due to manufacturing tolerances, which could affect antenna efficiency. However, in other embodiments, the flexible circuit board does not necessarily have to be split from the grounding part, and may be adjusted according to manufacturing process requirements. The disclosure is not limited thereto. For example, FIG. 4C is a side view schematic diagram of an antenna module according to an embodiment of the disclosure. FIG. 4D is an expanded schematic diagram of a flexible circuit board of the antenna module of FIG. 4C. Please refer to FIG. 4C and FIG. 4D. In an embodiment, an antenna module 100C includes a carrier 110C, a grounding part 120C, a first radiation part 130C, a feeding part F1, a second radiation part 140C, a matching part 150C, and a flexible circuit board 160C. The flexible circuit board 160C is split from the first coupling gap G1. In other words, the covering interface of the antenna module 100C is within the first coupling gap G1. The two ends of the folded flexible circuit board 160C, for example, generate a spacing on the top side T1 in FIG. 4A. The design with a spacing between two ends of the folded circuit board 160C may avoid overlapping of the flexible circuit board 160C due to manufacturing tolerances, which could affect antenna efficiency. However, the disclosure is not limited thereto.

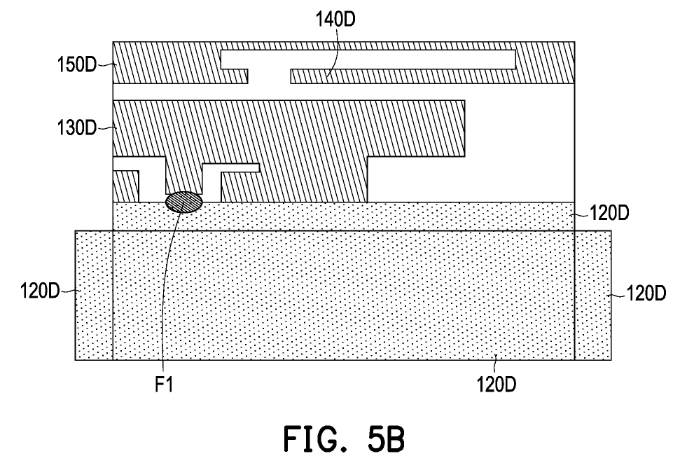

FIG. 5A is a three-dimensional schematic diagram of an antenna module according to an embodiment of the disclosure. FIG. 5B is an expanded schematic diagram of a carrier of the antenna module of FIG. 5A. To make the diagram clearer, FIG. 5B illustrates a carrier 110D expanded into a plane. In reality, the carrier 110D is a hexahedron, and multiple edges of the carrier 110D in FIG. 5B are actually connected to each other.

Please refer to FIG. 5A and FIG. 5B. In this embodiment, an antenna module 100D is slightly different from the antenna module 100B in FIG. 3. The main difference is that in this embodiment, all six sides of the carrier 110D (corresponding to a top side T1, a bottom side B1, a first side S1, a second side S2, a third side S3, and a fourth side S4) have antenna layouts, and may enhance antenna performance when integrated with the metal casing. For example, a grounding part 120D, a first radiation part 130D, a second radiation part 140D, and a matching part 150D may be directly formed on the carrier 110D by Laser Direct Structuring (LDS), but the disclosure is not limited thereto.

In this embodiment, the grounding part 120D is located on the bottom side B1 and extends to the second side S2, the third side S3, and the fourth side S4. Specifically, the second side S2, the third side S3, and the fourth side S4 may integrate the antenna isolation structure of the metal casing to prevent the antenna radiation toward the interior of the metal casing. The bottom side B1 serves as a grounding plane, which may be connected to the metal casing.

In this embodiment, the carrier 110D may integrate the open slot design that would be present in the metal casing, increasing the bandwidth of the antenna. Specifically, an open slot 170D may be, for example, disposed on the metal casing, with an open end 171D of the open slot 170D facing towards the first radiation part 130D. That is, the surface of the carrier 110D on the first side S1 is integrated into the metal casing, but the disclosure is not limited thereto.

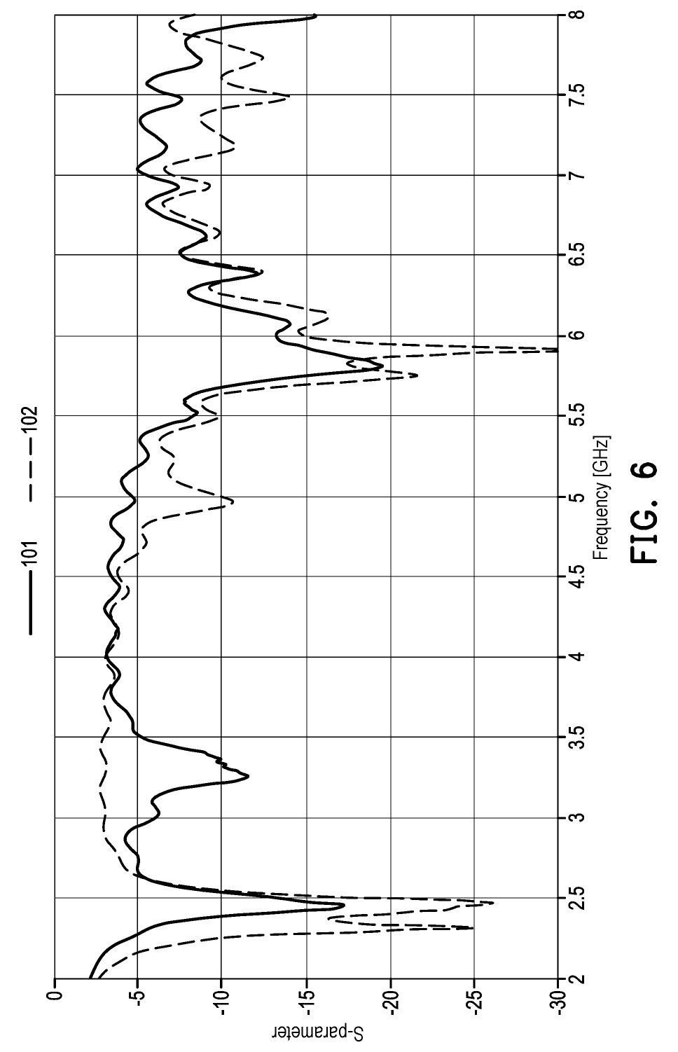

FIG. 6 is a relationship diagram of frequency versus S parameter between a traditional antenna module and an antenna module according to an embodiment of the disclosure. Please refer to FIG. 6, where a line segment 101 represents the traditional antenna module, and a line segment 102 represents the antenna module of this embodiment. The antenna module of this embodiment generates dual modes at the first resonant frequency (low frequency). Compared to traditional designs, the contribution from the first radiation part and the second radiation part results in a wider operational bandwidth performance, while also maintaining good antenna efficiency.

The following is an explanation of applying the antenna module to an electronic device.

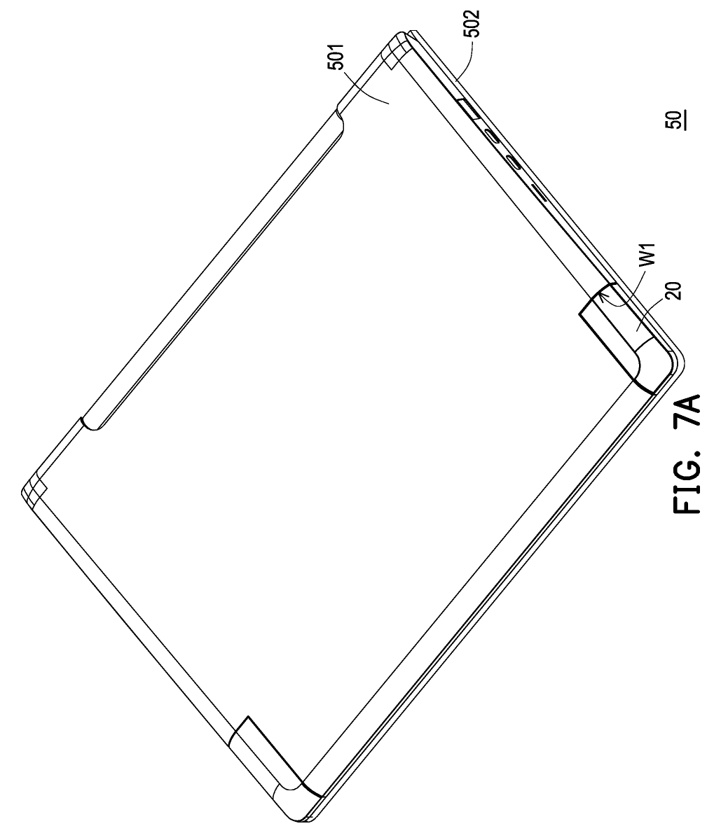

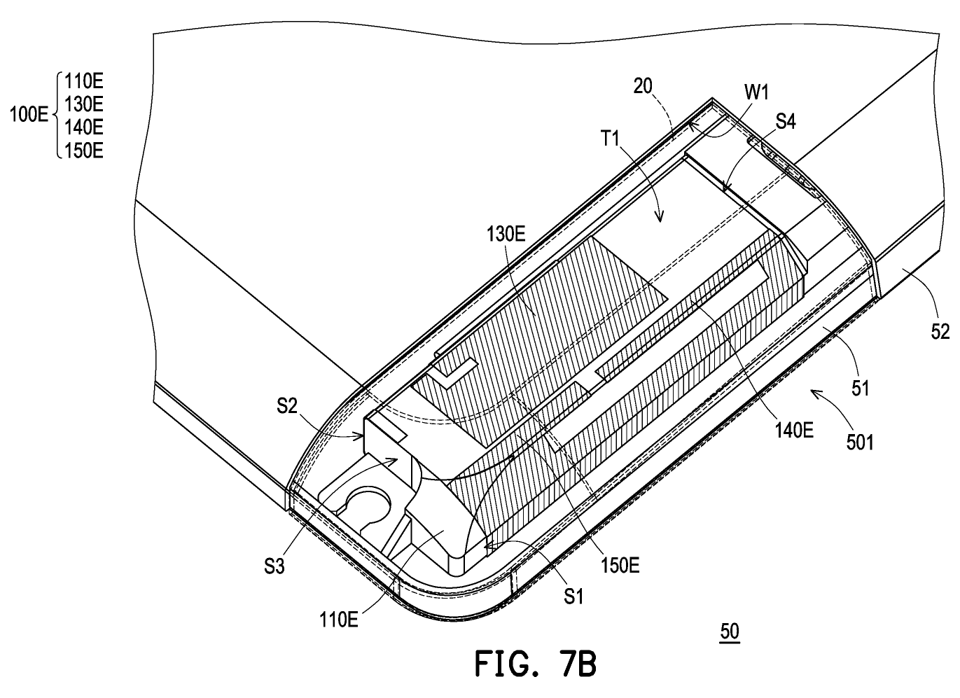

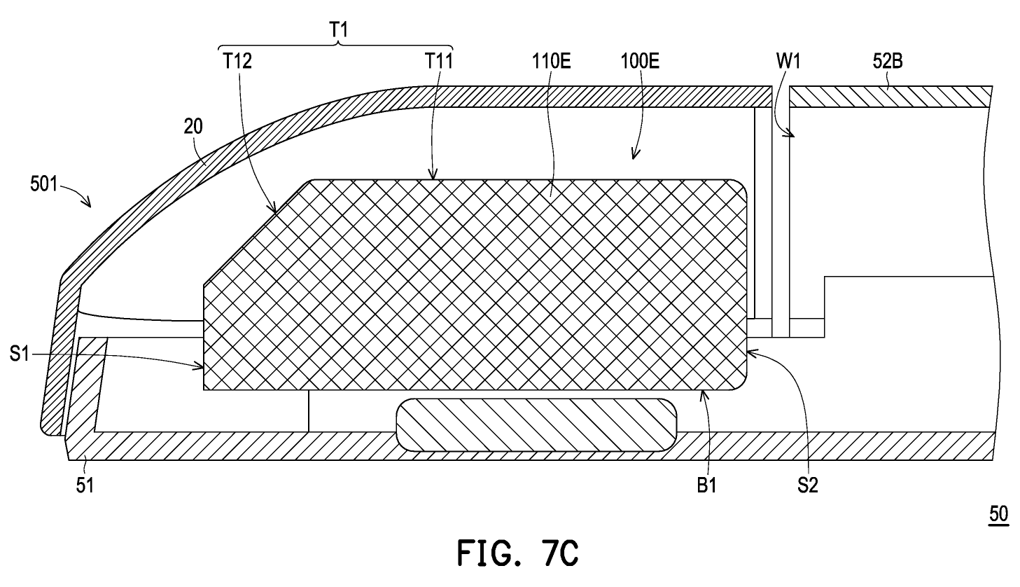

FIG. 7A is a three-dimensional schematic diagram of an electronic device according to an embodiment of the disclosure. FIG. 7B is a partially enlarged three-dimensional schematic diagram of the electronic device of FIG. 7A. FIG. 7C is a partially enlarged cross-section schematic diagram of the electronic device of FIG. 7B. To clearly show the relative positions between each component in this embodiment, a plastic component 20 in FIG. 7B is drawn in a perspective view.

Please refer to FIG. 7A to FIG. 7C. An electronic device 50 of this embodiment may be, for example, a laptop computer, which includes a display 502 and a host 501 pivotally connected to each other. The host 501 of the electronic device 50 includes a first metal casing 51, a second metal casing 52, and at least one antenna module 100E. In addition, the host 501 includes a motherboard, a processor, memory, and input/output devices.

In this embodiment, the second metal casing 52 is assembled on the first metal casing 51, and the second metal casing 52 has a window W1. The window W1 is filled with the plastic component 20, but the disclosure is not limited thereto. Here, the first metal casing 51 is a keyboard bezel (also known as component C), and the second metal casing 52 is a bottom casing (also known as component D), but the disclosure is not limited thereto.

In this embodiment, the antenna module 100E is disposed between the first metal casing 51 and the second metal casing 52, and adjacent to the window W1.

In this embodiment, the grounding part, a first radiation part 130E, a second radiation part 140E, and a matching part 150E may be directly formed on the carrier 110E by laser forming, but the disclosure is not limited thereto.

Please refer to FIG. 7C. A bottom side B1 of a carrier 110E faces the first metal casing 51, and a top side T1 of the carrier 110E faces away from the first metal casing 51. In this embodiment, the top side T1 has a first plane T11 and a second plane T12 to conform to the shape of the host 501, but the disclosure is not limited thereto. In this embodiment, the first radiation part 130E is located on the first plane T11, and the second radiation part 140E and the matching part 150E are located on the second plane T12, but the disclosure is not limited thereto.

Under the above configuration, the electronic device 50 may employ the antenna module 100E to comply with thin and lightweight product design, and employ the dual resonant mode design to improve the problem of insufficient operating bandwidth, thereby enabling the antenna module 100E to exhibit a wider operating bandwidth performance, while also maintaining good antenna efficiency.

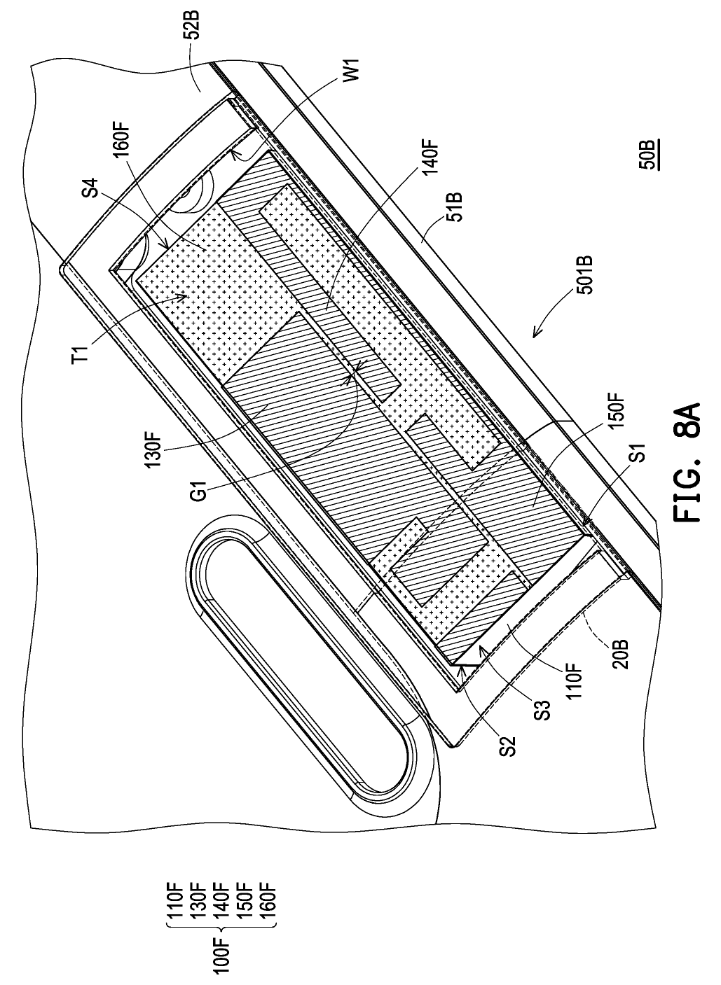

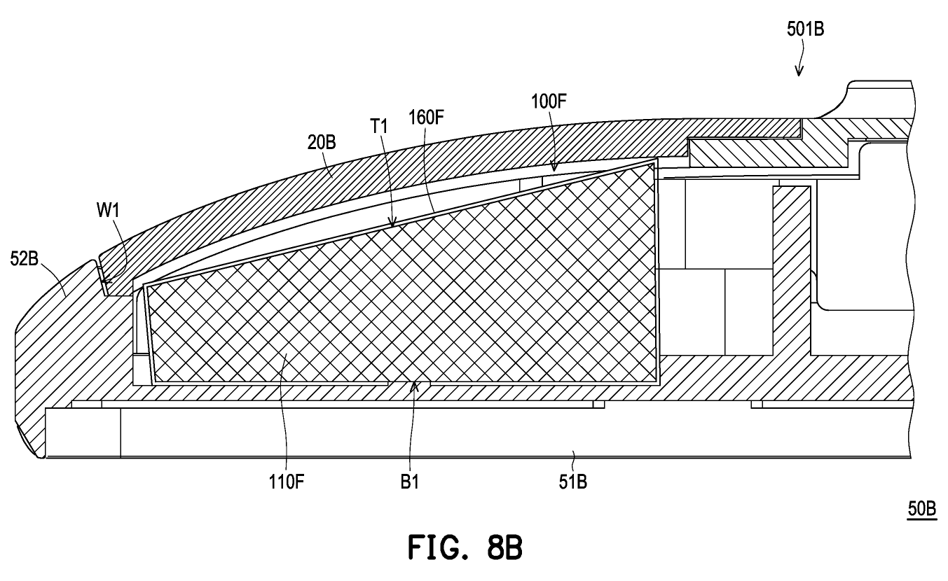

FIG. 8A is a partially enlarged three-dimensional schematic diagram of an electronic device according to an embodiment of the disclosure. FIG. 8B is a partially enlarged cross-section schematic diagram of the electronic device of FIG. 8A. To clearly show the relative positions between each component in this embodiment, a plastic component 20B in FIG. 8A is drawn in a perspective view.

Please refer to FIG. 8A and FIG. 8B. In this embodiment, an electronic device 50B is slightly different from the electronic device 50 in FIG. 7B. The main difference is that: the electronic device 50B of this embodiment includes a first metal casing 51B, a second metal casing 52B, and at least one antenna module 100F. The second metal casing 52B is assembled on the first metal casing 51B, and the second metal casing 52B has a window W1. The window W1 is filled with a plastic component 20B, but the disclosure is not limited thereto. A host 501B includes the first metal casing 51B and the second metal casing 52B. The first metal casing 51B is a keyboard bezel (also known as component C), and the second metal casing 52B is a bottom casing (also known as component D), but the disclosure is not limited thereto.

In this embodiment, the antenna module 100F is disposed between the first metal casing 51B and the second metal casing 52B, and adjacent to the window W1.

In this embodiment, the grounding part, a first radiation part 130F, a second radiation part 140F, and a matching part 150F are disposed on a flexible circuit board 160F, and the flexible circuit board 160F is used to cover the periphery of the carrier 110F to form the antenna module 100F.

In this embodiment, the first radiation part 130F, the second radiation part 140F, and the matching part 150F are located on a top side T1. Please refer to FIG. 8B, a bottom side B1 of a carrier 110F faces the first metal casing 51B, and the top side T1 of the carrier 110F faces away from the first metal casing 51B. The top side T1 is inclined towards a first side S1 to conform to the shape of the host 501B, but the disclosure is not limited thereto.

Under the above configuration, the electronic device 50B may employ the antenna module 100F to comply with thin and lightweight product design, and employ the dual resonant mode design to improve the problem of insufficient operating bandwidth, thereby enabling the antenna module 100E to exhibit a wider operating bandwidth performance, while also maintaining good antenna efficiency.

In summary, in the antenna module of this disclosure, the first radiation part and the grounding part are located on opposite sides of the carrier. The second radiation part and the matching part are located between the first radiation part and the grounding part, and may be disposed on the same plane as the first radiation part, or on two adjacent planes. The feeding part is located between the grounding part and the first radiation part. The first radiation part is excited by the feeding part and connected to the grounding part, resonating to generate a first resonant frequency band. The second radiation part couples with the first radiation part through the first coupling gap between them, resonating to generate a second resonant frequency band. The matching part may be used to adjust the second resonant frequency band and high-frequency matching. In one embodiment, the second radiation part and the matching part form an open slot, with the open end of the open slot facing towards the first radiation part. In one embodiment, the grounding part may integrate the antenna isolation structure of the metal casing to prevent the antenna radiation toward the interior of the metal casing. As a result, the antenna module may be applied in thin and lightweight product designs, employing the dual resonant mode design to improve the problem of insufficient operating bandwidth, thereby enabling the antenna module to exhibit a wider operating bandwidth performance, while also maintaining good antenna efficiency.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An antenna module, comprising:
a carrier;
a grounding part, at least a portion of the grounding part is located on a bottom side of the carrier;
a first radiation part, located on a top side of the carrier;
a feeding part, located between the grounding part and the first radiation part, wherein the first radiation part is excited by the feeding part and connected to the grounding part, resonating to generate a first resonant frequency band;
a second radiation part, located between the first radiation part and the grounding part, wherein the second radiation part is connected to the grounding part, and a first coupling gap is between the second radiation part and the first radiation part; and
a matching part, located between the first radiation part and the grounding part, and adjacent to the second radiation part, wherein the second radiation part couples with the first radiation part through the first coupling gap, resonating to generate a second resonant frequency band.

2. The antenna module according to claim 1, wherein the matching part is T-shaped, square, or L-shaped.

3. The antenna module according to claim 1, wherein a length of the second radiation part is 1/4 wavelength of the second resonant frequency band.

4. The antenna module according to claim 1, wherein the second radiation part and the matching part form an open slot.

5. The antenna module according to claim 4, wherein an open end of the open slot faces towards the first radiation part.

6. The antenna module according to claim 1, wherein the first radiation part is separated from the matching part.

7. The antenna module according to claim 1, further comprising a flexible circuit board covering the carrier, wherein the grounding part, the first radiation part, the second radiation part, and the matching part are disposed on the flexible circuit board.

8. The antenna module according to claim 1, wherein the grounding part, the first radiation part, the second radiation part, and the matching part are directly formed on the carrier by laser forming.

9. The antenna module according to claim 1, wherein the carrier is a speaker.

10. The antenna module according to claim 1, wherein the carrier further comprises a first side and a second side opposite to each other, located between the top side and the bottom side and perpendicular to the top side and the bottom side, the second radiation part and the matching part are located on the first side, and the grounding part extends to the second side.

11. The antenna module according to claim 10, wherein the carrier further comprises a third side and a fourth side opposite to each other, located between the top side and the bottom side, the third side and the fourth side are perpendicular to the top side and the bottom side and perpendicular to the first side and the second side, the grounding part extends to the third side and the fourth side.

12. The antenna module according to claim 1, wherein the second radiation part and the matching part are located on the top side, the carrier further comprises a first side and a second side opposite to each other, located between the top side and the bottom side and perpendicular to the top side and the bottom side, the grounding part extends to the first side and the second side.

13. The antenna module according to claim 12, wherein the top side is a plane.

14. The antenna module according to claim 12, wherein at least a portion of the top side is inclined relative to the bottom side.

15. An electronic device, comprising:
a first metal casing;
a second metal casing, assembled to the first metal casing, and the second metal casing having a window; and
the antenna module according to claim 1, disposed between the first metal casing and the second metal casing and adjacent to the window, wherein the bottom side of the carrier faces the first metal casing, and the top side of the carrier faces away from the first metal casing.
